(19) United States
(12) Patent Application Publication
(10) Pub. No.: US 2011/0238535 A1
(43) Pub. Date: Sep. 29, 2011

(54) Systems and Methods for Making and Using Interactive Display Table for Facilitating Registries

(76) Inventor: Dean Stark, Toronto (CA)

(21) Appl. No.: 13/073,894

(22) Filed: Mar. 28, 2011

Related U.S. Application Data
(60) Provisional application No. 61/318,242, filed on Mar. 26, 2010.

(51) Int. Cl. G06Q 30/00; G06F 3/048

(52) U.S. Cl. 705/27.1; 715/835; 715/836; 705/27.2

(57) ABSTRACT

An interactive display of goods. On a screen, platform, or other suitable surface, images of items are shown or projected, preferably in high definition and/or 3D. A user may inspect or select any of the items. A computer or other processing unit may supply the content of the images. Preferably, realistic 3D images of objects are rendered by graphics design software enabling the user to select an item, rotate it, and view it from any angle.

### CROSS-REFERENCE TO RELATED APPLICATIONS

The present application is a non-provisional application which claims the benefit of U.S. Provisional Application No. 61/318,242 entitled “Systems and Methods for Making and Using Interactive Display Table for Facilitating Registries,” filed Mar. 26, 2010, which is hereby incorporated by reference in its entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the patent and trademark office patent file or records, but otherwise reserves all copyright rights whatsoever.

### FIELD OF INVENTION

The present invention relates to the field of shopping for goods and, in particular, to the inspection and selection of items from an interactive video image display located on a platform or projected on a screen or other suitable surface.

### BRIEF SUMMARY OF THE INVENTION

The Interactive Display Table may, in one embodiment, enable users to select gifts for a registry or baby shower or other such similar event, and may be used in conjunction with a manufacturer of furniture, dining ware or gifts that may usually be purchased for a bridal registry or baby shower or other such event, e.g. Nordstrom's, William Ashley. The Interactive Display Table displays a large plurality of relevant gifts or items all in one place and all in one view or image on a very large table surface so that the customer need not scroll around a webpage for instance or flip through pages of a magazine or newspaper ad to actually view the large plurality of items they are interested in purchasing. By combining the large surface area of a table with dynamic audiovisual content or hyper-realistically rendered 3D content, the Interactive Display Table presents a large plurality of relevant items that the customer wishes to purchase all in one place to enable a streamlined and efficient shopping experience.

In other words, the mechanical aspects of the table tied together with the projected or displayed content that displays a large plurality of gift items all at once presents a customer with a seamless shopping experience. The large plurality of gift items is on average 40-50 items for a bridal registry. Usually, the large plurality of gift items ranges from 20-100 items, or even more. Nonetheless, the large plurality of gift items is a large enough number so as to require scrolling when viewing the items on a web browser or on the small screen of a mobile phone device. Displaying the large plurality of gift items digitally on the surface of a table saves the user the trouble of having to scroll through multiple pages or areas.

These and other objects and advantages of the present invention will become clear to those skilled in the art in view of the description of the best presently known mode of carrying out the invention and the industrial applicability of the preferred embodiment as described herein.

### BRIEF DESCRIPTION OF THE DRAWINGS

The embodiments are illustrated by way of example and not limitation in the figures of the accompanying drawings in which like references indicate similar elements.

FIG. 1 shows a system to make and use an Interactive Display Table for facilitating registries according to one embodiment.

FIG. 2 shows an example system using an Interactive Display Table for facilitation registries according to one embodiment.

FIG. 3a shows an example projection system for interactive facilitation registries according to one embodiment.

FIG. 3b shows an example Interactive Display Table with a monitor for facilitation registries according to one embodiment.

FIG. 4 shows a method for presenting Interactive Display Table features to a user.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one. The use of headings herein are merely provided for ease of reference, and shall not be interpreted in any way to limit this disclosure or the claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

### Overview of Interactive Display Table

The Interactive Display Table may be, in one embodiment, a large flat surface where images and/or video are projected upon it in 2D or 3D from a projector located elsewhere in the room. In another embodiment, the Interactive Display Table may be a large flat surface screen such as, for example, an LCD screen or thin plasma display screen, and accordingly be able to display images and/or video in 2D or 3D. The surface screen of the Interactive Display Table may be enhanced with 3DTV or HDTV capabilities so as to enhance the clarity of images or video perceived. The Interactive Display Table in this scenario may be connected to a computer or other processing unit which would supply the content to display on the large flat surface screen.

In another embodiment, the projected or displayed images onto the Interactive Display Table may be static or moving images, or a combination of both static and/or moving images. The projected or displayed video(s) and/or animations may be of any type that can be readily displayed or viewed on a standard display screen. The projected or displayed video content may be re-rendered before being displayed on the Interactive Display Table.

In another embodiment, the projected or displayed content may be hyper-realistically rendered 3D objects of tangible gift items so as to present the user with a very realistic 3D shopping experience. The hyper-realistic 3D objects are not mere photographs: they are actual rendered objects that can be rotated and viewed from all angles, as if the real gift item (e.g. teapot, dining set) were in front of the user. The hyper-realistic 3D objects may be rendered in sophisticated graphics design software such as, for example, Autodesk's 3ds Max, 3D STUDIO MAX, or MAYA programs, or any equivalent advanced graphics design software used to render hyper-realistic 3D objects. This content may be provided in a server off-site so that when loaded or displayed, there need not be excessive load times or the requirements to download excessively large plug-ins or other associated files for the rendered objects to display or the graphics design software to run. In another embodiment, tangible gift objects may be shown far away on the Interactive Display Table as merely orbs, but when the user zooms in, they will appear as more realistically rendered 3D objects with increasingly fine and precise detail. The hyper-realistically rendered 3D content may be re-rendered or enhanced before being displayed on the Interactive Display Table.

The Interactive Display Table may also provide optional touch interaction and sensor feedback using video touch technology or other technologies such as, for example, infrared ultrasonic RFID (Radio Frequency Identification), active RFID, barcode etc. and so on. The Interactive Display Table may be oriented flat like the surface of a normal table, or may be propped up vertically up against a wall, or arranged diagonally, or in any direction where images and/or video may be projected upon it, and where users may view the projected content.

In another embodiment, the Interactive Display Table may be able to transmit relevant display information to a mobile cellular phone, PDA (e.g. Blackberry), smart phone (e.g. HTC device, iPhone) or other mobile computing device in order to display the projected image content upon the smaller screen of the applicable mobile device.

The image and/or video content that may be displayed on the Interactive Display Table (by projection or on the flat surface screen of the Interactive Display Table) may be provided in associated software. Furthermore, software may be utilized to manage the projection and/or display of the image and video content and the operation of various components used with the Interactive Display Table, or the Interactive Display Table itself

The Interactive Display Table is not limited to touch technologies or touch interaction and can also be entirely video or entirely hyper-realistically 3D content and triggered instead with speech commands, not requiring the user to touch the display at all.

The Interactive Display Table is able to display all the associated or relevant items desired to be purchased in one view, all in front of a user. The Interactive Display Table can perform this because it is using the large surface area of a table. Essentially, the user is presented his/her selected gifts in a tactile, visual “very big newspaper” experience: where everything is laid out in front of the user, but the user need not flip pages or go to different sections. A large layout of different gift objects is presented to the user all at one time and all the gift objects are visible all at once on the Interactive Display Table, so this experience is quite unlike having to scroll around on web pages of an online shopping site, or browsing or shopping for things on the small screen of a smart phone or mobile device.

In one embodiment, the Interactive Display Table may be 5-6 feet in diameter if a circular or oval shape, or 5-6 feet on each dimension (horizontal and vertical) if in a rectangular or square shape. In another embodiment, the Interactive Display Table may be up to 10 feet in diameter if a circular or oval shape, or 10 feet on each dimension (horizontal and vertical) if in a rectangular or square shape. In other embodiments, the relevant dimensions may be 3-4 feet in diameter or in horizontal-vertical dimensions.

In one embodiment the projection/display resolution used by the Interactive Display Table may be Blu-Ray resolution. In another embodiment, the resolution may be up to 2000×5000. In another embodiment, the resolution may be on average to be 640×640.

### Overview of Using the Interactive Display Table For Registries

According to an embodiment, the Interactive Display Table may be used to facilitate the process of selecting gifts for bridal registries. For example, an entire selection of couples gifts (gifts selected by the bride and groom) would appear on the Interactive Display Table all at one time and viewable or visible all at once on the large table surface area of the Interactive Display Table, and guests would be encouraged to come out to the store and use the Interactive Display Table and its capabilities to search the registry by price, category or color. All of these operations may be done on the surface of the Interactive Display Table.

By enabling users or customers to search for registry items in one location and displaying all the relevant gift items all in one view on the large surface area of the Interactive Display Table, much time would be saved. This effortless and efficient method of presenting one location or one view where gifts in large stores could be searched, located and ultimately arranged and displayed would significantly alleviate the current scavenger hunt that guests must burdensomely endure in order to locate gifts or view them. Once the gifts are found, they may be hyper-realistically rendered as 3D objects right on the large surface area of the Interactive Display Table so the users may turn them around and inspect them from all angles to see if the gifts are satisfactory, without having to go and find the object themselves. In addition, pre-recorded video of the object in use may also be shown to give the customer a full sense of the object. In summary, the Interactive Display Table solves the problem of guests wasting time traversing the store and locating gifts in different departments of the store or even at different stores. The Interactive Display Table brings all the gifts (and all the gifts listed in a registry) to one location, viewable or visible all at once in one view, so that the customer need not waste their time searching for gifts or other products, or waste time scrolling around a website or a mobile phone device searching for gift items.

In another embodiment, an image or rendered 3D object or video of each gift the couple has selected would appear for the guests to make selections on without having to track down the actual physical whereabouts of the item in store. By touching the image or 3D object or video of the item on the Interactive Display Table, a user would be able to obtain further details about the product, its price and its actual location within the store, without having to waste time tracking down the item. The gift item may also be hyper-realistically rendered in 3D so that the customer may flip the object around and view it from all angles and/or colors so as to see if the object is satisfactory, without even having to request the object to be brought to them or having to be brought to the object. Pre-recorded video showing the gift object being used may also be shown to give the user a fuller sense of the gift object. The gift item, however, can also always be brought to the customer for a direct inspection, even after viewing the hyper-realistically rendered 3D content or video, without the user having to leave the Interactive Display Table or another centralized location.

In another embodiment, to display a specific registry, an user could view the images of the Interactive Display Table on a cell phone by initiating the cellphone at the Interactive Display Table, view the registry at the Interactive Display Table through a kiosk associated with the Interactive Display Table, or on the surface screen of the Interactive Display Table itself.

In another embodiment, to display the registry of the Interactive Display Table via a cellphone, a user could call up the registry via the Internet on his or her cellphone, specify the store location, and choose to take control of the Interactive Display Table within a certain distance using a PIN (Personal Identification Number) associated with the Interactive Display Table. Performing this process will instantly display the couples selection of gifts on a user's cellphone. As a result, the entire purchase process may be facilitated by the Interactive Display Table and removed from the couple's selections of gifts in order to avoid duplicate gift purchases from the couple's selection of gifts.

Registry purchases are immediately updated across the country of purchase, so registry accuracy is maintained in real time.

Enabling customers to view all the relevant registry gift items all in one place and all in one convenient view encourages customers to go to the store and take advantage of the Interactive Display Table in order to make their shopping experience a streamlined, interesting and enjoyable one.

### DESCRIPTION OF THE FIGURES

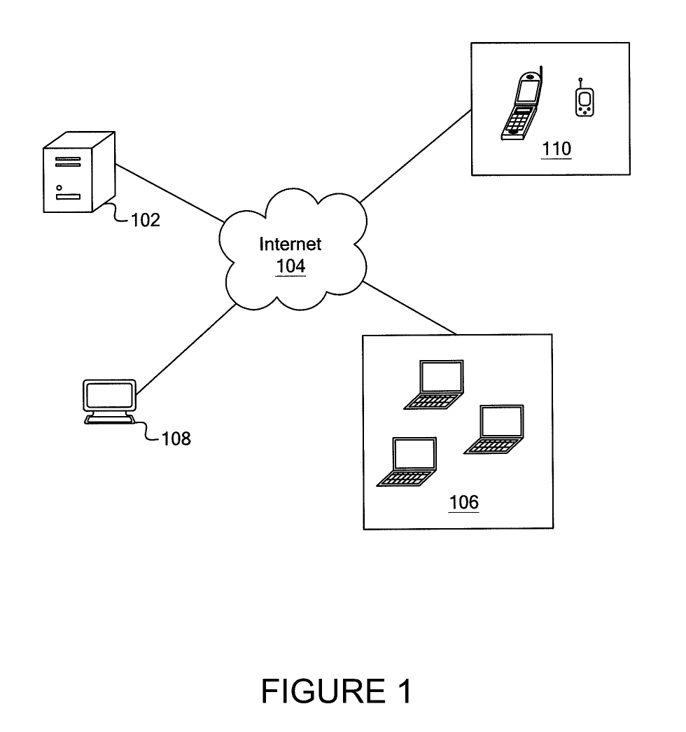

FIG. 1 shows a system to make and use an interactive display table for facilitating registries according to one embodiment. Specifically, FIG. 1 illustrates a server connected to at least one terminal through a network, wherein the server stores software according to an embodiment of the present disclosure. Software or program code directed to functions and data structures which can be used in, for example, an interactive virtual marketing environment triggering emotional response in customers, may be tied to remote server 102. Remote server 102 is connected to the Internet 104, and the Internet 104 is in turn connected to at least one computer 108 by a direct connection, to at least one mobile computer 106 via a wireless connection or a direct connection, and to at least one cellular phone or mobile device 110, the cellular phones and mobile devices being configured to receive streaming video, internet-based content or Wireless Application Protocol (WAP) based content. The at least one cellular phone and mobile device 110 can comprise, for example, cell phones, smart phones, PDAs, blackberries, iPhones, and so on and so forth.

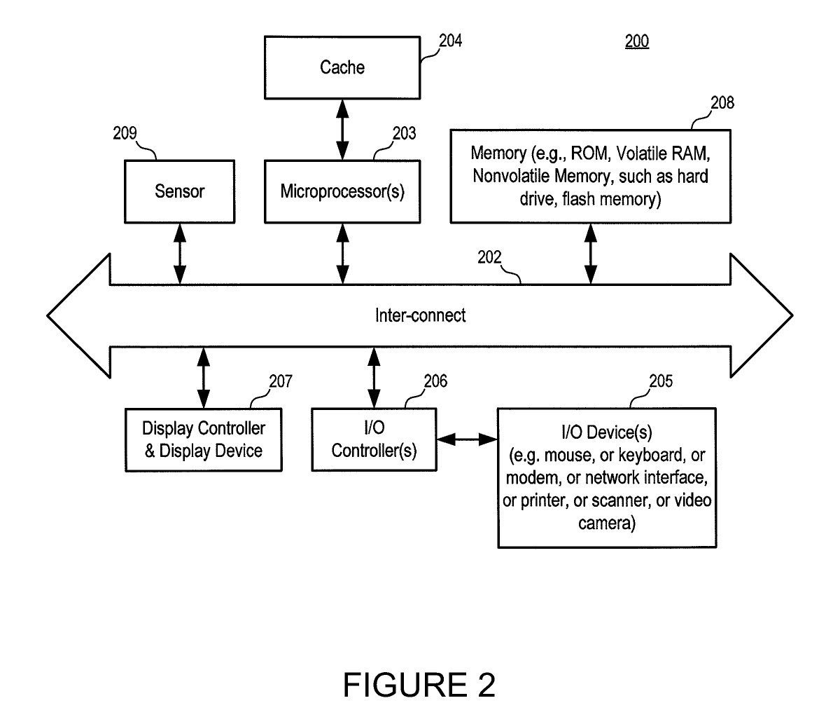

FIG. 2 shows an example system using an interactive Display table for facilitation registries according to one embodiment. While FIG. 2 illustrates various components of a computer system, it is not intended to represent any particular architecture or manner of interconnecting the components. Some embodiments may use other systems that have fewer or more components than those shown in FIG. 2.

In FIG. 2, the data processing system 200 of an user terminal includes an interconnect 202 (e.g., bus and system core logic), which interconnects a microprocessor(s) 203 and memory 208. The microprocessor 203 is coupled to cache memory 204.

The inter-connect 202 interconnects the microprocessor(s) 203 and the memory 208 together and also interconnects them to a display controller, display device 207, the sensor 209 and to peripheral devices such as input/output (I/O) devices 205 through an input/output controller(s) 206. The sensor 209 may include, for example, an accelerometer to determine the orientation of the user terminal and/or to detect the shaking of the user terminal, or hand motions near the user terminal, or as another example, audio recording equipment to record sound near the user terminal.

Typical I/O devices include mice, keyboards, modems, network interfaces, printers, scanners, video cameras, touch pads, microphones and other devices which are well known in the art. In some embodiments, when the data processing system is a server system, some of the I/O devices, such as printer, scanner, mice, and/or keyboards, are optional.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

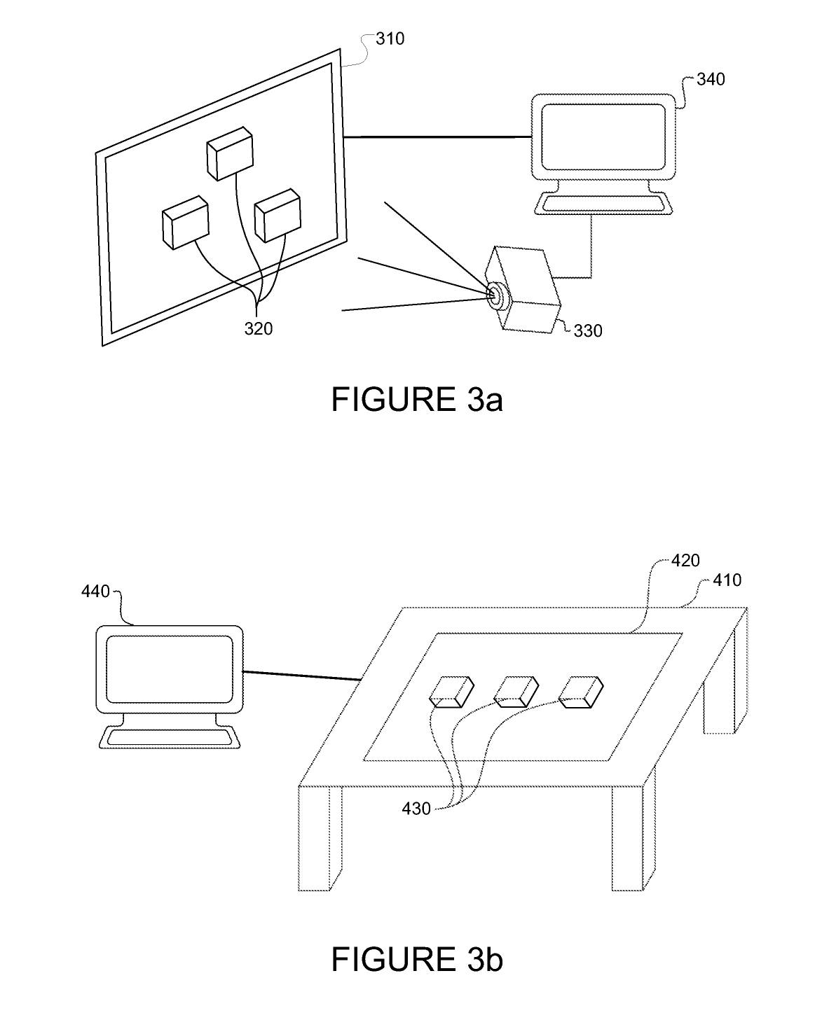

FIG. 3a shows an embodiment of the present invention in which a projector 330 displays items 320 for selection and/or purchase on a surface 310, which may be a vertical surface, for example, or may be a table top. Preferably, the displayed items 320 are in high definition 3D and are in motion and/or rotating. The projector may be either in front of the surface or in back of the surface given a surface that enables rear projection mode. Optional computer 340 controls the projector and the surface, allowing users to examine displayed items, move them as desired, and rotate them.

FIG. 3b shows an embodiment of the present invention in which a table 410 includes a monitor 420 displaying items 430 for purchase. The monitor 420 may or may not be embedded horizontally in a table. It may be vertical for example. Preferably, the monitor is high definition 3D. Preferably, the displayed items 430 are in motion and/or rotating. Optional computer 440 controls the monitor and a surface, allowing users to examine displayed items, move them as desired, and rotate them.

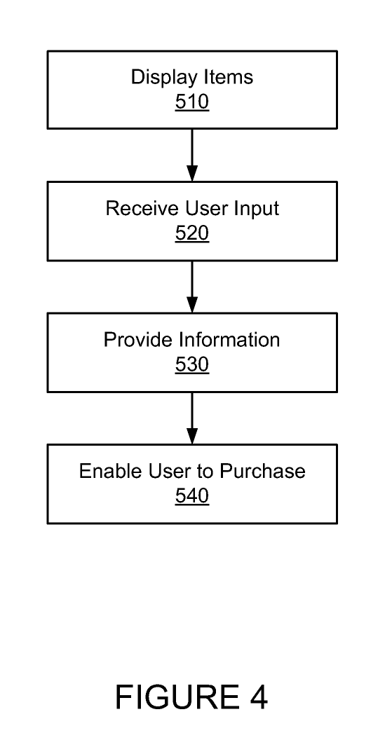

FIG. 4 is a flow chart illustrating a method of displaying the items and permitting user interaction with apparatus described above. First, items are displayed on a surface 510, preferably moving and/or rotating, projected thereon or displayed by means of a monitor. Then user input is received 520. The user input may comprise commands to select items, move items, and rotate items. Information is provided 530 to the user. And the user may be enabled to purchase 540 the items.

The memory 208 may include ROM (Read Only Memory), volatile RAM (Random Access Memory), and non-volatile memory, such as hard drive, flash memory, etc.

In the foregoing specification and the following appended documents, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects. In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

A machine readable medium also can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Portions of the data and instructions can also be obtained dynamically, just in time, when needed for execution. Thus, it is not required that the data and instructions be on a machine readable medium in entirety at a particular instance of time.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to the data processing system through a network interface such as a modem or Ethernet interface, can also be used.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

The computer-readable media may store the instructions. In general, a tangible machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The disclosure includes methods and apparatuses which perform these methods, including data processing systems which perform these methods, and computer readable media containing instructions which when executed on data processing systems cause the systems to perform these methods.

While the methods and systems have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

In this regard it should be understood that for practical reasons and so as to avoid adding potentially hundreds of claims, the applicant has presented claims with initial dependencies only.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible in accordance with the following claims.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. An apparatus comprising:
means for presenting on a display one or more images of one or more items; and
means enabling a user to interact with the images,
wherein the means permit the user to select images of the items and/or inspect the images.

2. The apparatus of claim 1 wherein the images are rendered in high definition.

3. The apparatus of claim 1 wherein the images are rendered in 3D.

4. The apparatus of claim 1 wherein the user may rotate the images.

5. The apparatus of claim 1 wherein the display is a substantially flat surface.

6. The apparatus of claim 1 wherein the display is a table having a substantially flat screen.

7. The apparatus of claim 1 wherein the means project the images onto the display.

8. The apparatus of claim 1 wherein the means present the images on a video monitor.

9. The apparatus of claim 1 wherein the images are static images.

10. The apparatus of claim 1 wherein the images are moving images.

11. An interactive display table facilitating purchases, comprising:
a surface; and
interactive audiovisual content projected upon the surface all in one view that is entirely visible to a user all at once,
wherein the interactive audiovisual content displays relevant items to purchase.

12. The display of claim 11 wherein the surface is substantially flat.

13. The display of claim 11 wherein the surface is a table surface.

14. A computer-implemented method, comprising:
displaying, via a computing device, relevant items to purchase in one location and all in one view on a surface;
receiving tactile or audio-based input from a user on the surface concerning a selected relevant item;
providing information about the selected item; and
enabling the user to purchase the selected item if desired.

15. The display of claim 14 wherein the surface is substantially flat.

16. The display of claim 14 wherein the surface is a table surface.

17. An interactive display facilitating purchases, comprising:
a surface screen; and
interactive audiovisual content displayed on the screen all in one view that is visible to a user all at once,
wherein the interactive audiovisual content displays relevant gifts to purchase.

18. The display of claim 17 wherein the surface is substantially flat.

19. The display of claim 17 wherein the surface is a table surface.
